(19) United States
(12) Patent Application Publication
(10) Pub. No.: US 2007/0022135 A1
(43) Pub. Date: Jan. 25, 2007

(54) Systems and methods for organizing and annotating an information search

(76) Inventor: Dale Malik, Atlanta, GA (US)

Correspondence Address: BAMBI FAIVRE WALTERS, PO BOX 5743, WILLIAMSBURG, VA, 23188, US

(21) Appl. No.: 11/188,933

(22) Filed: Jul. 25, 2005

(51) Int. Cl. G06F 7/00

(52) U.S. Cl. 707/102

(57) ABSTRACT

These exemplary embodiments utilize a flexible, Information Search Organizer tool for capturing, accessing, and otherwise managing user-defined indexing (and/or a bookmark) of a website, user-defined content selected from the website, and/or a user-defined annotation for the selected website and/or the selected content. According to exemplary embodiments, a communications device includes a Information Search Organizer tool stored in memory. The Information Search Organizer tool is an application that may operate separately or simultaneously with a world wide web or Internet session to access a website (or other electronic communications address), select content of an electronic file, create an annotation, and save the annotation in an annotation profile that is associated with a search term and/or search category, information associated with content of the website, a key word of the annotation, and/or other information selected by the user.

### CROSS REFERENCE TO RELATED APPLICATION

This application relates to patent application entitled “Systems and Methods for Automatically Updating Annotations of an Information Search” by Dale Malik (Attorney Docket No. BS040256) filed concurrently herewith, and incorporated herein by this reference.

### NOTICE OF COPYRIGHT PROTECTION

A portion of the disclosure of this patent document and its figures contain material subject to copyright protection. The copyright owner has no objection to the facsimile reproduction by anyone of the patent document or the patent disclosure, but otherwise reserves all copyrights whatsoever.

### BACKGROUND

The exemplary embodiments relate to the field of annotated information management systems, and more particularly, to methods and systems for creating, integrating, and managing a user-defined annotation to an electronic file and/or to an electronic communications address associated with electronic information.

Conventional world wide web and/or Internet browsers enable a user to navigate through websites (also referred to herein as a “website”) to view and access electronic information. Some browsers include navigation tools that allow the user to backtrack to a previously visited website. Similarly, some browsers include tools that allow the user to move forward from a “backtracked” website to a website that was successively viewed after the “backtracked” website. These types of tools are often referred to as a “session history” because they record websites during a session from initiation to termination of the browser application. Some of these tools only record a single path of websites while others record multiple paths of websites during the session as is understood by those of ordinary skill in the art. Regardless of the “session history” tool, the user is overwhelmed with disorganized information from the uncorrelated path(s) of websites and is further limited to website information recorded during the particular session.

Another navigation approach saves a “global history” tool that records every website that the user visits. However, there is a lack of context associated with the global history. And, while the paths may sometimes be sorted by a date, there are drawbacks when a website has been visited on more than one date—that is, most “global history” tools update the date stamp of a recorded website with the most current date that the website is visited (and not a history of date stamps for each time the website is visited), and, thus, the user may not pull up the visited website if an earlier date is used to search for websites within an earlier timeframe. Still, other limitations exist with. “global history” tools that use a date stamp to organize and sort the visited websites, such as having the user remember the timeframe for the search or associating related searches during a different timeframe.

Still, another navigation approach uses a “bookmark” tool that records and saves a selected website address to an archive. Some of the “bookmark” tools are directed at organizing large archives, such as automatically classifying a website according to a search term(s) or according to contents of the bookmarked website. However, these “bookmark” tools offer limited sorting capabilities and often do not enable the user to select particular content from the website (e.g., the bookmark tool selects universal metadata of the website, such as a title of a document, an abstract, a key word, and so on).

Consequently, users of the world wide web and/or Internet suffer information overload—that is, conventional navigation tools lack an organized structure for identifying, accessing, organizing, mapping, and/or managing websites and/or electronic information available from a website. For example, oftentimes, the user may visit a website with valuable information, but not retain or otherwise remember the website address (e.g., URL, IP/SSP, and others), website session and/or date, or the search terms used to find and select the website. And, even if the user remembers the website address, the user may not identify why the website is preferred over another website with similar information. Further, additional needs exist to associate, store, and manage websites and electronic information available from a website with other information.

### SUMMARY

The exemplary embodiments include methods, systems, computer programs, and/or computer program products that address the above needs and others by providing flexible navigation tools for accessing, updating, and otherwise managing user-defined indexing (and/or a bookmark) of a website (or alternate electronic data file), user-defined marked content selected from the website, a user-defined annotation for the selected website and/or associated with the selected content, and other associated electronic information with the website, marked content, and/or the annotation (e.g., a remote spreadsheet, a contact of an electronic address book, a word processing document, a graphical file, and others).

According to exemplary embodiments, a communications device, such as a personal computer, includes an Information Search Organizer tool stored in memory. The Information Search Organizer tool is an application that may operate separately or simultaneously with a world wide web or Internet session. For example, during an Internet session, the Information Search Organizer tool may display a toolbar with a website that includes information associated with a search term and/or search category, information associated with content of the website, information associated with the user, buttons to “select” content from the website, buttons to “mark” the selected content (or alternatively the website) with a personalized annotation, and other functions.

Other exemplary embodiments provide an Information Search Organizer tool to access, select, and store information from another source and/or application with a search term, search category, website address, annotation, or other user-defined information. For example, the Information Search Organizer tool enables the user to select and save a website with a personal annotation along with an electronic communication, such as an email sent to a customer service department of the selected website. Additionally, other types of electronic information may be accessed and associated with the Information Search Organizer tool, such as locally stored, electronic documents (e.g., word processing, address/contact information, spreadsheets, pictures, video files, audio files, and other data) and other accessible electronic information of a remote communications device to the communications device (e.g., the personal computer may communicate with a user's personal digital assistant (PDA) and/or cellular phone) to access, select, and/or store applications and/or data of the remote communications device.

Further exemplary embodiments include means for presenting the annotations of the Information Search Organizer tool along with a history (e.g., the website, selected content of the website, selected content of another application or data) in a separate or an integrated graphical user interface, such as incorporating the annotations into the information of the website (e.g., integrated text inserted in a selected portion of an HTML page). Still further, the annotation, the marked content, and/or other associated electronic information with a date and/or time stamp (or alternate tracking means) may be saved for offline viewing (e.g., when the personal computer is not communicating with or otherwise connected to the world wide web or Internet). Thereafter, the Information Search Organization tool may automatically update or otherwise modify the annotation, the marked content, and other associated electronic information. The automatic update may operate according to synchronization rules that may be established by the user or alternatively that may run according to default synchronization rules, such as, for example, updating the annotation, the marked content, and other associated electronic information over a set time period (e.g., every 24 hours) or when an update to the annotation, the marked content, and/or other associated electronic information is detected (e.g., comparing a time and/or date stamp to see if the time and/or date stamp of the last saved information matches (or doesn't match) a time and/or date stamp of existing information (and if it doesn't match, then automatically updating the information). Alternatively, the user may manually edit an Information Search Organization Topic (and/or subtopic) and activate a “refresh” button to update the annotation, marked content, and/or other associated information. Further, the Information Search Organizer tool may archive all copies of the Information Search Organizer Topic (and/or subtopic) such that the initial and all subsequent updates are saved for offline viewing, outlined and/or otherwise indexed for presentment with a history of the Information Search Organization Topic (and/or subtopic), and available for playback (and additional editing or managing). Thus, the Information Search Organizer tool provides flexible features for accessing, modifying, automatically updating, refreshing, and/or otherwise managing information related to the search category, key words, marked content, an electronic address of the website, and/or an associated electronic file.

Other systems, methods, and/or computer program products according to these and other embodiments will be or become apparent to one with skill in the art upon review of the following drawings and detailed description. It is intended that all such additional systems, methods, and/or computer program products be included within and protected by this description and be within the scope of this invention.

### DESCRIPTION OF THE DRAWINGS

The above and other embodiments, objects, uses, advantages, and novel features are more clearly understood by reference to the following description taken in connection with the accompanying figures, wherein:

FIG. 1 illustrates a block diagram of exemplary details of a communications device having a personal annotations and navigation module according to some of the embodiments;

FIG. 2 shows an exemplary operating environment of the communications device of FIG. 1 according to some of the embodiments;

FIG. 3 illustrates exemplary data fields associated with an electronic website, a search field, an application, and/or other electronic information and additional associated fields of user information, rules, and network provided information according to some of the embodiments;

FIG. 4 depicts an exemplary graphical user interface showing the Information Search Organizer tool interfacing a website with exemplary annotator tools on the right hand side of the GUI according to some of the embodiments;

FIG. 5 depicts the exemplary graphical user interface of FIG. 4 further illustrating annotations embedded within and simultaneously displayed with the text of the website.

FIG. 6 depicts another exemplary graphical user interface illustrating an annotations field for inserting personalized annotations with functions for saving, prioritizing, and linking the personalized annotation along a similar right hand GUI that includes additional information related to the selected website, application, and/or electronic file according to some exemplary embodiments;

FIG. 7 depicts still another exemplary graphical user interface illustrating an annotations index and listing of websites and/or communications addresses according to some exemplary embodiments;

FIG. 8 depicts a further exemplary graphical user interface illustrating an outline of annotations and marked content along with corresponding websites and/or communications addresses organized by a search name (referred to as “Name of Annotation Profile” in FIG. 7) according to some exemplary embodiments;

FIG. 9 depicts another exemplary graphical user interface illustrating a refreshed outline of FIG. 8 according to some exemplary embodiments;

FIG. 10 depicts an exemplary graphical user interface of a website with an exemplary popup (or alternate graphical and/or audio presentation) indicating the website has at least one associated annotation and/or marked content according to some exemplary embodiments;

FIG. 11 depicts an exemplary graphical user interface of a website with an exemplary popup (or alternate graphical and/or audio presentation) indicating that an electronic file has at least one associated annotation and/or marked content according to some exemplary embodiments;

FIGS. 12-13 depict other exemplary graphical user interfaces for playback of an Information Search Organization Profile (and/or topic/subtopic) according to some exemplary embodiments; and

FIG. 14 depicts yet another exemplary graphical user interface illustrating creating, managing, and saving features for the Information Search Organizer tool according to some exemplary embodiments.

### DETAILED DESCRIPTION

The exemplary embodiments now will be described more fully hereinafter with reference to the accompanying drawings. The exemplary embodiments may, however, be embodied in many different forms and should not be construed as limited to the embodiments set forth herein. These embodiments are provided so that this disclosure will be thorough and complete and will fully convey the scope of the invention to those of ordinary skill in the art. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, flowcharts, illustrations, and the like represent conceptual views or processes illustrating systems, methods and computer program products embodying this invention. The functions of the various elements shown in the figures may be provided through the use of dedicated hardware as well as hardware capable of executing associated software. Those of ordinary skill in the art further understand that the exemplary hardware, software, processes, methods, and/or operating systems described herein are for illustrative purposes and, thus, are not intended to be limited to any particular named manufacturer.

The exemplary embodiments include methods, systems, computer programs, and/or computer program products for providing flexible navigation tools for capturing, accessing, updating, refreshing, and otherwise managing user-defined indexing (and/or a bookmark) of a website address (or alternate electronic data address for an electronic file, such as, for example, a remotely stored word processing document), user-defined content selected from the website, and/or a user-defined annotation for the selected website and/or the selected content. According to exemplary embodiments, a communications device, such as a personal computer, includes an Information Search Organizer tool stored in memory. The Information Search Organizer tool is an application that may operate separately or simultaneously with a world wide web, Internet session, or alternate communications session(s) with remote computing systems. For example, during an Internet session, the Information Search Organizer tool may display a toolbar with a website that includes information associated with a search term and/or search category, information associated with content of the website, information associated with the user, buttons to “select”, “mark”, and/or “save” content from the website (or the URL or alternate communications address of a file), buttons to “mark” content from the website and associate and “save” a personalized annotation with the “marked” content of website or with the address of the website, and other functions.

Further exemplary embodiments provide the Information Search Organizer tool with features to access, select, store, update, refresh, and/or otherwise manage information from another source and/or an application with a search term, a search category, a website address, an annotation, marked content, and/or other user-defined information. For example, the Information Search Organizer tool enables the user to select and save a website address (and/or marked content) with a personal annotation along with an electronic communication, such as an email sent to a customer service department of the selected website. Additionally, other types of electronic information may be accessed and associated with the Information Search Organizer tool, such as locally stored, electronic documents (e.g., word processing, address/contact information, spreadsheets, pictures, video files, audio files, and other data) and other accessible electronic information of a remote communications device to the communications device (e.g., the personal computer may communicate with a user's personal digital assistant (PDA) and/or cellular phone) to access, select, and/or store applications and/or data of the remote communications device.

Further exemplary embodiments include means for presenting the annotation, marked content, website address, and/or other associated electronic information of a Information Search Organizer profile (also referred to herein as an Information Search Organizer (ISO) Topic and/or subtopic) along with a history in a separate or an integrated graphical user interface, such as incorporating the annotations into the information of the website (e.g., integrated text inserted in a selected portion of an HTML page). Still further, the annotation, the marked content, and/or other associated electronic information with a date and/or time stamp (or alternate tracking means) may be saved for offline viewing (e.g., when the personal computer is not communicating with or otherwise connected to the world wide web or Internet). Thereafter, the Information Search Organization tool may automatically update or otherwise modify the annotation, the marked content, and other associated electronic information. The automatic update may operate according to synchronization rules that may be established by the user or alternatively that may run according to default synchronization rules, such as, for example, updating the annotation, the marked content, and other associated electronic information over a set time period (e.g., every 24 hours) or when an update to the annotation, the marked content, and/or other associated electronic information is detected (e.g., comparing a time and/or date stamp to see if the time and/or date stamp of the last saved information matches (or doesn't match) a time and/or date stamp of existing information (and if it doesn't match, then automatically updating the information). Alternatively, the user may manually edit an Information Search Organization Topic (and/or subtopic) and activate a “refresh” button to update the annotation, marked content, and/or other associated information. Further, the Information Search Organizer tool may archive all copies of the Information Search Organizer Topic (and/or subtopic) such that the initial and all subsequent updates are saved for offline viewing, outlined and/or otherwise indexed for presentment with a history of the Information Search Organization Topic (and/or subtopic), and available for playback (and additional editing or managing). Thus, the Information Search Organizer tool provides flexible features for accessing, modifying, automatically updating, refreshing, and/or otherwise managing information related to the search category, key words, marked content, an electronic address of the website, and/or an associated electronic file.

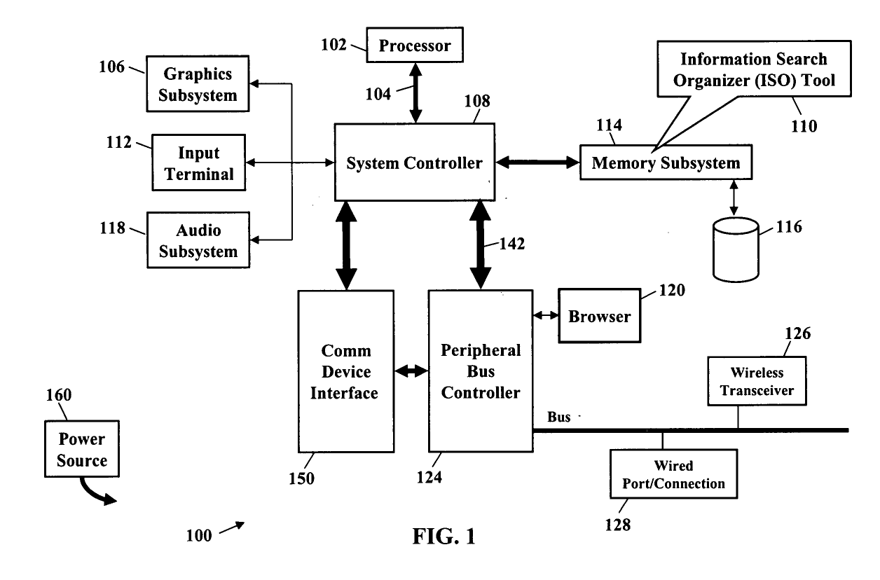

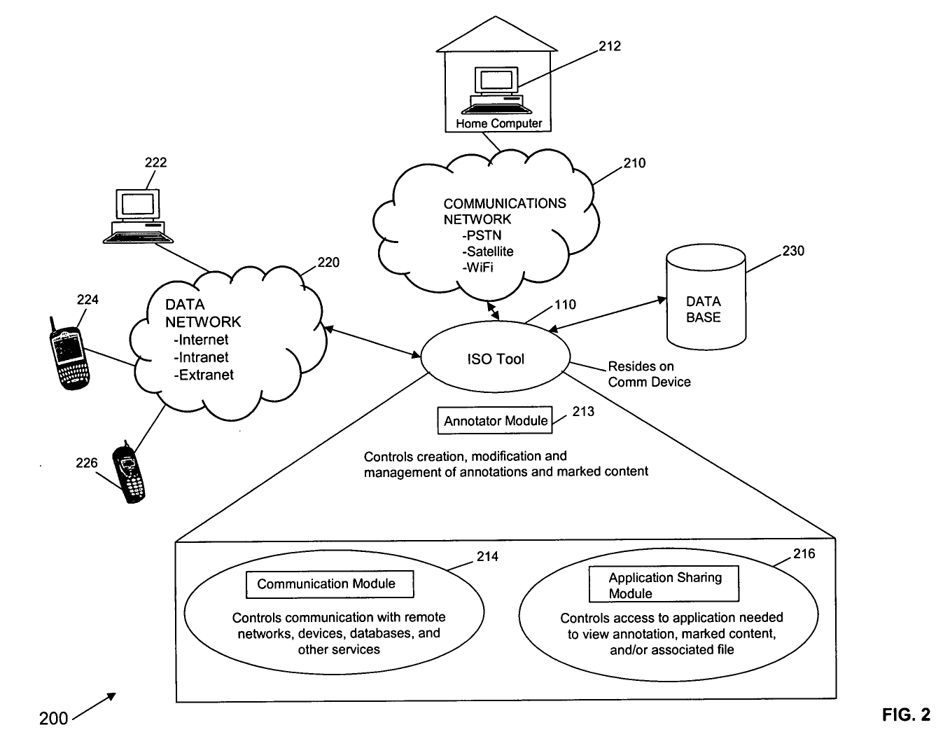

Referring now to the figures, FIG. 1 is a block diagram showing a Information Search Organizer tool 110 residing in a computer system shown as a personal computer 100. As FIG. 1 shows, the Information Search Organizer tool 110 operates within a system memory device. The Information Search Organizer tool 110, for example, is shown residing in a memory subsystem 114. The Information Search Organizer tool 110, however, could also reside in flash memory or a peripheral storage device 116. The personal computer 100 also has one or more central processors 102 executing an operating system. As one skilled in the art would appreciate, the operating system has a set of instructions that control the internal functions of the personal computer 100, and furthermore has the capability to communicate a communications signal among the personal computer 100, a communications network (e.g., reference numeral 210 in FIG. 2), a local area network of remote communications device (e.g., reference numeral 220 in FIG. 2) that may include a connected electronic device capable of communicating audio, graphical, and/or other sensory data (e.g., a TV integrated with the personal computer 100, a wireless transceiver in an electronic device such as a remote control device, an appliance, a communications device, and/or other devices), and a remote database (e.g., reference numeral 230 in FIG. 2).

The system controller 108 provides a bridging function between the one or more central processors 102, a video/graphics subsystem 106, an input terminal 112, and an audio subsystem 118, the memory subsystem 114, a PCI (Peripheral Controller Interface) bus, and a Communications (“Comm”) Device Interface 150. The PCI bus is controlled by a Peripheral Bus Controller 124. The Peripheral Bus Controller 124 (typically called a “Southbridge”) is an integrated circuit that serves as an input/output hub for various peripheral ports and/or transceivers. The Peripheral Bus Controller 124 allows for communications with the communications network and any connected electronic device. The peripheral ports allow the personal computer 100 to communicate with a variety of devices through networking ports (such as SCSI or Ethernet, not shown) and/or transceivers that include Wireless Communications (“Comm”) Device Transceiver 126 (for communication of any frequency signal in the electromagnetic spectrum, such as, for example, Wireless 802.11 and Infrared) and Wired Communications (“Comm”) Device Port/Connection 124 (such as modem V90+ and compact flash slots). These peripheral ports could also include other networking ports, such as, a serial port (not shown) and/or a parallel port (not shown). Further, a browser application 120 provides a search tool for interfacing and searching a world wide website and/or other electronic communications address (including an Internet address). The browser application 120 may be stand-alone as shown in FIG. 1 or alternatively, the browser application 120 may reside in the memory subsystem 114 of the personal computer 100. If the Information Search Organizer tool 110 uses the web browser 120, then an application server may respond to Hyper-Text Transfer Protocol (HTTP) requests by processing the requested URL and parameters according to the services it is providing. This may require accessing and/or storing data (e.g., annotations) in database 116. According to an exemplary embodiment, the Information Search Organizer tool 110 stores the annotations and related information (e.g., selected website, content, link to remote electronic file, and/or link to an application) as Extensible Style Sheet (XSL) documents that allow the XML annotations and information to be translated into HTML using an XSL processor. A server application (such as a server within a communications network) could then translates the XML data into HTML data and transmits it to the web browser 120 that presents the HTML data of a display device of the graphics subsystem 106, such as a computer monitor or a television screen. According to another exemplary embodiment, Real Simple Syndication (RSS) that uses XML structures may be similarly used to store the annotations and related information. Still further, the personal computer 100 may include a power source 160, such as a power cord that plugs into an electrical socket, a rechargeable battery to provide power and allow the personal computer 100 to be portable, and/or others. Additionally, those of ordinary skill in the art understand that the program, processes, methods, and systems described in this patent are not limited to any particular computer system or computer hardware.

As those of ordinary skill in the art would appreciate, the central processor 102 may be implemented with a microprocessor. Advanced Micro Devices, Inc., for example, manufactures a full line of ATHLON™ microprocessors (ATHLON™ is a trademark of Advanced Micro Devices, Inc., One AMD Place, P.O. Box 3453, Sunnyvale, Calif. 94088-3453, 408.732.2400, 800.538.8450, www.amd.com). The Intel Corporation also manufactures a family of X86 and P86 microprocessors (Intel Corporation, 2200 Mission College Blvd., Santa Clara, Calif. 95052-8119, 408.765.8080, www.intel.com). Other manufacturers also offer microprocessors. Such other manufacturers include Motorola, Inc. (1303 East Algonquin Road, P.O. Box A3309 Schaumburg, Ill. 60196, www.Motorola.com), International Business Machines Corp. (New Orchard Road, Armonk, N.Y. 10504, (914) 499-1900, www.ibm.com), and Transmeta Corp. (3940 Freedom Circle, Santa Clara, Calif. 95054, www.transmeta.com). Those skilled in the art further understand that the program, processes, methods, and systems described in this patent are not limited to any particular central processor of a manufacturer.

The operating system may be a UNIX® operating system (UNIX® is a registered trademark of the Open Source Group, www.opensource.org). Other UNIX-based operating systems, however, are also suitable, such as LINUX® or a RED HAT® LINUX-based system (LINUX® is a registered trademark of Linus Torvalds, and RED HAT® is a registered trademark of Red Hat, Inc., Research Triangle Park, N.C., 1-888-733-4281, www.redhat.com). Other operating systems, however, are also suitable. Such other operating systems may include a WINDOWS-based operating system (WINDOWS® is a registered trademark of Microsoft Corporation, One Microsoft Way, Redmond Wash. 98052-6399, 425.882.8080, www.Microsoft.com) and Mac® OS (Mac® is a registered trademark of Apple Computer, Inc., 1 Infinite Loop, Cupertino, Calif. 95014, 408.996.1010, www.apple.com). Those of ordinary skill in the art again understand that the program, processes, methods, and systems described in this patent are not limited to any particular operating system.

As shown in an exemplary operating environment 200 of FIG. 2, the Information Search Organizer tool 110 of personal computer 100 includes an annotator module 213, a communications module 214, and an application sharing module 216. The Information Search Organizer tool 110 communicates with many sources of electronic information, such as, for example, a website address of the world wide web. These sources include a local area network 220 of remote devices that include another personal computer 222, a personal digital assistant (PDA) 224, and a cellular phone 226, a communications network 210 that connects to the world wide web and that enables communications with other remote devices, such as a home personal computer 212, and a remote database 230. The communications network 210 may be a distributed computing network, such as, for example, a cable network operating in the radio-frequency domain and/or the Internet Protocol (IP) domain. The communications network 210, however, may also include the Internet (sometimes alternatively known as the “World Wide Web”), an intranet, and/or a wide-area network (WAN). The communications network 210 and the local area network 220 may include coaxial cables, copper wires, fiber optic lines, and/or hybrid-coaxial lines. These communications networks 210 and 220 may also include wireless portions utilizing any portion of the electromagnetic spectrum and any signaling standard (such as the I.E.E.E. 802 family of standards).

According to an exemplary embodiment, the personal computer 100 may activate an online session to the world wide web using browser 120 to search for a website and use the annotator module 212 of the Information Search Organizer tool 110 to select and to mark content of a website to save, to create an annotation and/or a modification of the annotation (or mark-up), and to manage the annotation and/or the marked content. Similarly, the personal computer 100 may communicate with remote communications devices 212, 222, 224, and 226 and/or a remote database 230 and use the communications module 214 of the Information Search Organizer tool 110 to control or otherwise facilitate communications with these remote communications devices, networks, and/or remote databases such that electronic data and/or an application can be selected, marked, annotated, and/or otherwise managed. Further, the Information Search Organizer tool 110 includes (or alternatively interfaces with) the application sharing module 216 to control access and/or activation of an application needed to present the electronic data, marked content of a website, the annotation, and/or other associated electronic files, other marked content (of the website or another website), and/or another annotation. According to a further exemplary embodiment, the Information Search Organizer tool 110 may store the annotation, selected content, website, and/or other information to the memory subsystem 114 and/or to a peripheral storage device, such as home computer 212. For example, a user may communicate a stored annotation topic, subtopic(s), and/or profile that includes the selected and marked content of an electronic communications address (e.g., URL, HTML, remote electronic device, and other electronic addresses), annotations, a copy of the website (or alternate electronic data address) and website data at the time of the annotation (or copies of the website and website data for each marked selections and/or annotations having a different search or creation date), and/or other electronic information to another personal computer 222, PDA 224, or cellular phone 226.

According to an exemplary embodiment, the Information Search Organizer tool 110 completes many intelligent functions, including accessing an electronic file (or website, etc.) receiving selected (and/or otherwise marked) content of the electronic file, creating the annotation, storing the selected content and/or annotation, exchanging the annotation and/or selected content (or electronic file, website, etc.), presentation of, and/or control of the annotation, selected content, electronic file, website, and/or electronic data address (of an associated electronic file). To facilitate these functions, the Information Search Organizer tool 110 generates graphical user interfaces (also referred to as “menu screens”) and accepts viewer menu instructions, commands, and/or selections, such as, for example, search terms, prompts to select, mark, and/or store a portion of the content of the website (or alternate electronic data address), prompts to create an annotation associated with selected and marked content of the website, and prompts to create rules for the marked content and/or the annotation including rules to associate the annotation with one or more websites, selected content of a website, an electronic file, one or more search terms, an information search organizer topic (and/or subtopic), an application, and/or customized preferences established by a user. Based on these instructions, commands, and/or selections, the Information Search Organizer tool 110 receives and stores selected (or otherwise marked) content, annotations, search terms, search history (e.g., website content for each date the content is initially marked, subsequently retrieved, or associated with an initial or a subsequent annotation), and/or associated data from communications networks 210 and 220 and remote database 230.

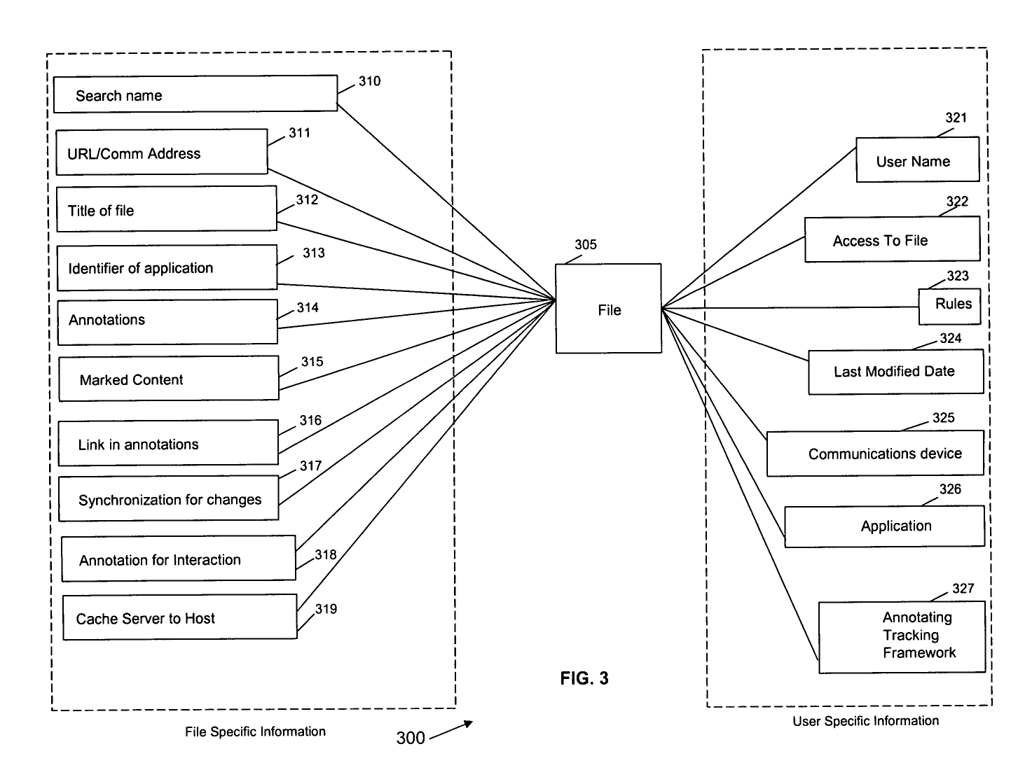

FIG. 3 illustrates an exemplary overview 300 of data fields associated with a website, an electronic data address, an application, and/or other electronic information (referred to as “File” 305 in FIG. 3) and additional associated fields of user information, rules, and network provided information according to some of the exemplary embodiments of this invention. For example, file specific data (e.g., metadata including annotated data and rules associated with the electronic file, website, electronic data address, and/or other selected electronic information) is shown on the left hand side. This file specific data may include an information search organizer topic 310 (e.g., a user provided name of a topic (including subtopics) for creating, modifying, organizing, and/or otherwise managing an annotated search of electronic information), URL or alternate electronic data address 311, title (or name) of the file 312, identification of an application for presenting the file 313, one or more annotations associated with the file 314, selected or otherwise marked content of the file 315, link or marker for selecting an insertion location of the annotation (or associating another communications address, marked content, or another annotation) within the file 316, a synchronization instruction for changes 317 (e.g., an instruction to refresh selected or otherwise marked content within a specified time period, an instruction to refresh or update the annotation (or associated annotation, associated files, and other information sources), an interaction instruction or rule for the annotation and/or marked content 318 (e.g., saving a history of the website when the annotation is initially created, each time the annotation is modified or refreshed, and/or each time the annotation is associated with a new topic and/or subtopic, providing a history of the annotation including edits over time, and/or taking an action based on the annotation, such as initiating a sell order for a stock when it reaches a price in the annotation), and a cache server to host field 319 for accessing the file 305 on the communications network 210 and/or data network 220 and/or the remote database 230. On the right hand side is shown user specific information that includes a user name 321, access and/or authorization instructions to the file 322, rules for managing an annotation 323, a date stamp 324 such as a last modified date for the annotation (or for the file 305 or for marked content 315), a communications device 325 such as remote home personal computer 212, an application for presenting the file 326, and annotation tracking framework 327 for setting up user preferences (e.g., taking an action based on an annotation like opening an electronic mail application to send a communication related to the annotation if the annotation includes an electronic mailing address).

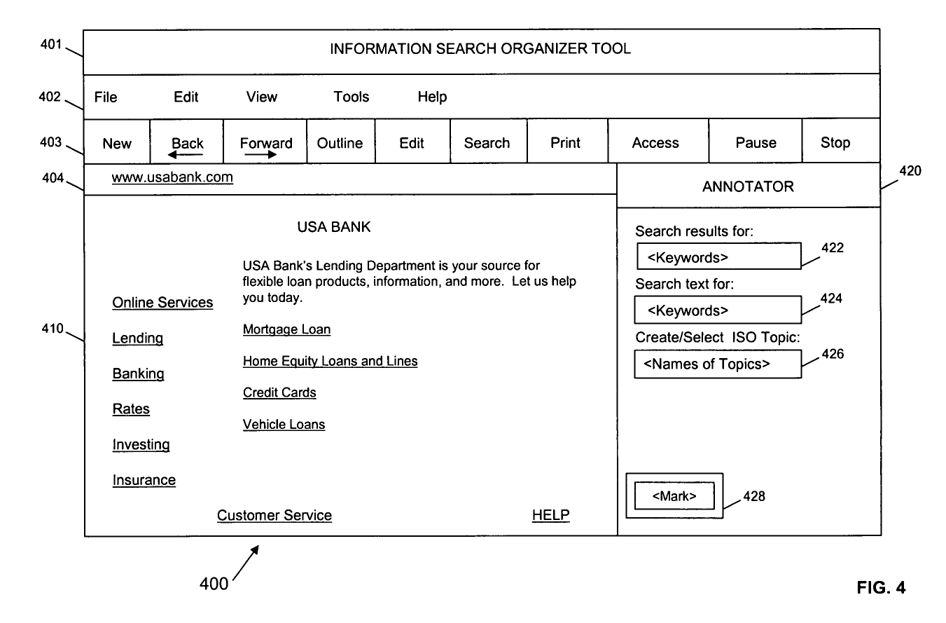

The display of the Information Search Organizer tool 110 can be any number of graphical overlays or independent screens, depending on the particular network resources (e.g., graphical user interfaces) and system components including software of the display device of the personal computer 100. For example, the display can be a pop-up window, a small tool bar, or full page presentation similar to the exemplary graphical user interfaces shown in FIGS. 4-11.

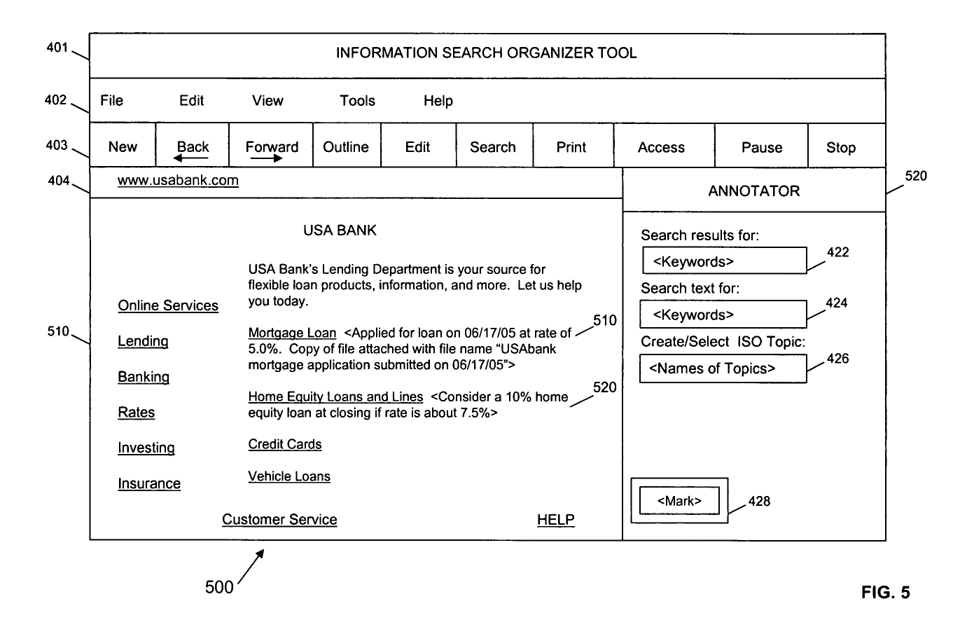

Referring now to FIG. 4, an exemplary graphical user (GUI) interface 400 of the Information Search Organizer tool 110 is presented with exemplary content of a selected website—www.usabank.com. The display depicted in FIG. 4 includes a field 401 to alert the user that the Information Search Organizer tool 110 is activated and includes tool bars 402 and 403 for managing and navigating the selected website. The communications address of the selected website is shown in field 404 and the website itself is presented in an integrated screen 410. An annotator window 420 is shown on the right hand side and includes fields for search results that include key words of the search 422, a field for searching content of the website 424, a field to create or to select a search topic 426, and a prompt to select, mark, and/or otherwise save content of the website or associate the content with an annotation 428. FIG. 5 depicts another exemplary graphical user interface 500 that further illustrates annotations 510 and 520 embedded within and simultaneously displayed with the selected content of the website of FIG. 4.

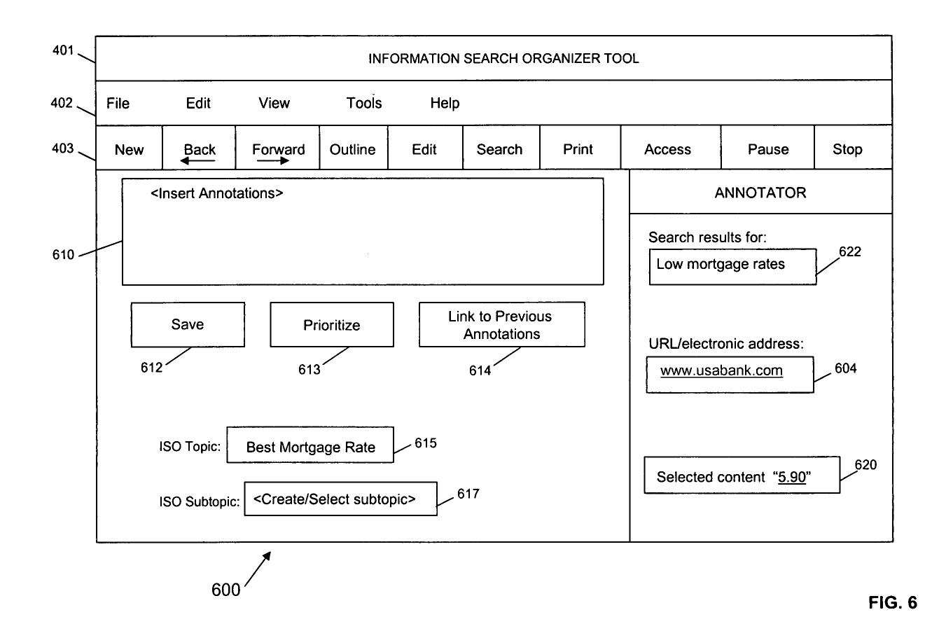

Once the user activates the prompt to mark or otherwise select content of the website 428, a graphical user interface 600 of FIG. 6 is presented to the display device of personal computer 100. The user may then insert annotations in field 610 and activate another prompt to save the annotation associated with the marked content and/or to save the marked content 612, to prioritize or otherwise establish a rule for the annotation 613, to link the annotation with a previous annotation (or alternatively with another search topic/subtopic, other marked content, another website (or file), and other information sources) 614, to display the selected or otherwise created ISO Topic 615 (selected or created using reference numeral 424 in FIGS. 4-5), and to select or create an ISO Subtopic 617. In addition, the right hand annotator window may include the keywords of the search result 622, the URL or alternate communications address of the selected website 604 (previously shown as field 404 in FIGS. 4 and 5), and the marked content 620 (shown as “5.90” in FIG. 6) to save and/or to associate with the annotation 610.

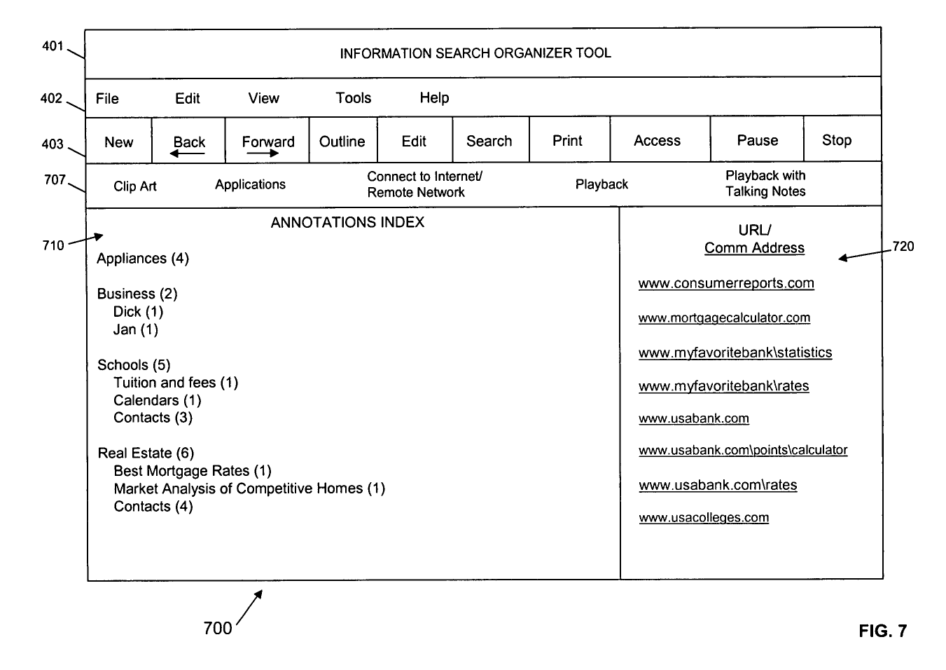

The Information Search Organizer tool 110 creates an annotations index 710 and/or URL (or alternate communications address) database 720 as shown in an exemplary graphical user interface 700 of FIG. 7. For example, the annotation index 710 may be an alphabetical presentation of search terms or keywords for an ISO Topic (or a subtopic), key words searched within the website, key words of the annotation, and/or key words of the annotation. In an exemplary embodiment, the user may use an “Outline” button of toolbar 403 to establish one of the organization methods to arrange the index 710. Each index term or keyword may further include a number (shown in parentheses to the left of the term or keyword) that indicates a total number of annotations associated with the term or keyword (or alternatively a total number of selected websites associated with the term or keyword). Further, the listing of selected URLs or communications addresses for annotations 720 may similarly be shown in alphabetical order (or alternatively by a selected priority input by the user or by an association with the right hand index 710). Similarly, each URL or communications address may include a numeric identifier that corresponds to a total number of annotations and/or marked content for that URL or communications address, such as a parenthetical beside the URL with the number. Toolbars 403 and 707 enable the user to organize, modify, link, and/or otherwise manage the annotation, the selected/marked content, and/or to create another annotation, select/mark other content, and/or link to an electronic file. For example, the user may activate the “Edit” button of toolbar 403 to modify annotations, marked content, selected website, and/or other associated electronic information of an existing ISO Topic (and/or subtopic). Another example includes the user activating the “Connect to Internet/Remote Network” of toolbar 707, navigate to a website, select or otherwise mark content, and create and associate an annotation for the ISO Topic/Subtopic selected from the index 710.

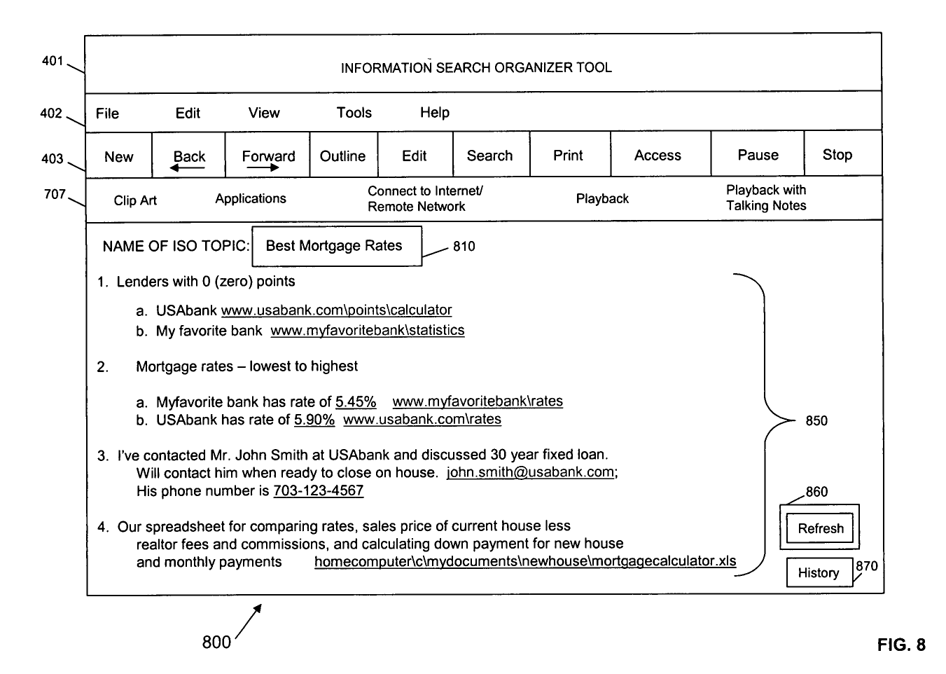

According to some of the exemplary embodiments, the Information Search Organizer tool 110 presents a graphical user interface 800 as shown in FIG. 8 that enables a broad range of functionality for organizing, modifying, storing, linking, and/or otherwise managing annotations with a selected website, selected/marked content of a website, a selected electronic file, and/or a selected application. As FIG. 8 illustrates, the name of an ISO topic is shown in field 810 (shown as “Best Mortgage Rates) and a corresponding outline 850 of organized annotations, selected content, website and/or other electronic communications addresses, contact information, and/or associated remote files is presented. The outline may be created using subtopics (e.g., reference numeral 617 of FIG. 6), rules to prioritize the annotation (e.g., reference numeral 613 of FIG. 6), and/or by activating the “Outline” button shown on toolbar 403 to establish rules and preferences for arranging the ISO Topic. Toolbars 403 and 707 may be used to organize, modify, link, and/or otherwise manage the annotation, the selected/marked content, and/or to create another annotation, select/mark other content, and/or link to an electronic file.

In the exemplary outline 850 of FIG. 8, the annotations and associated information is for the ISO Topic “Best Mortgage Rates” 810. A first subtopic or a first level of an annotation or search category (if prioritized or otherwise customized by the user) may include “Lenders with zero (0) points” followed by a list of URLs and/or other electronic communications addresses of lenders that meet a criterion of 0 points. The criterion of “0 points” may used as search terms or keywords to run an internet search and create a preliminary list of website addresses that include the search terms or keywords. A second subtopic or second level may organize the lenders (e.g., websites) using another criterion, such as “mortgage rates” to search for mortgage rates in the websites of the first subtopic, select or otherwise mark the mortgage rates, and then use prioritizing rules to organize the list of websites from lowest to highest mortgage rates. Then, a third subtopic or sublevel, may include actions taken by the user and include other useful information such as, for example, identifying a contact of a selected website and marking contact information. Still further, a fourth subtopic or fourth level, may include an annotation and a link to other related information, such as a spreadsheet that compares rates, points, down payments, closing fees, and other financial factors for a mortgage.

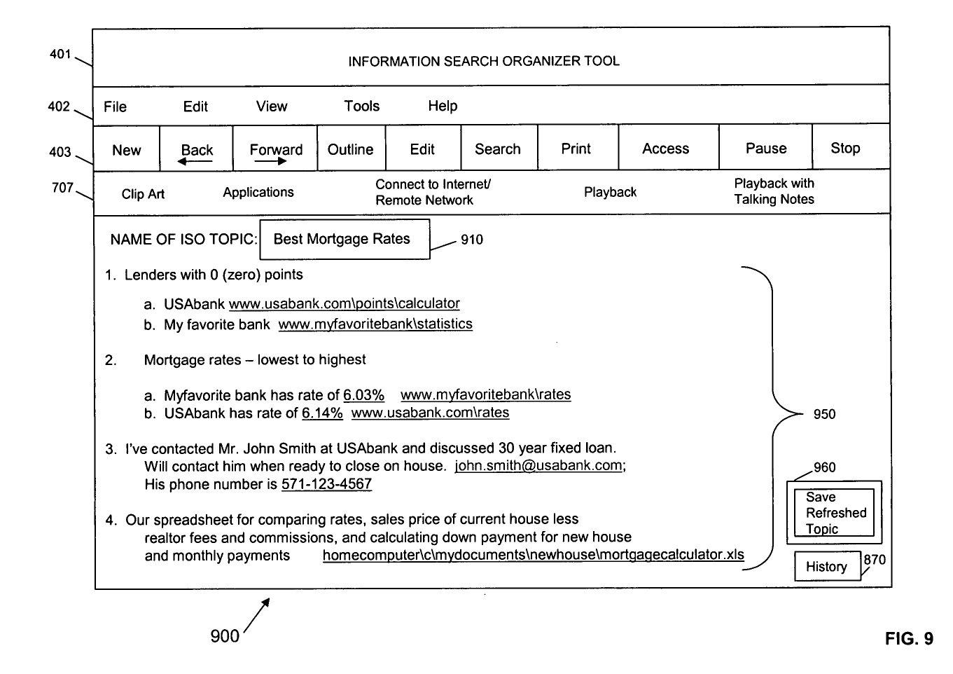

In further exemplary embodiments, the user may activate a “refresh” button 860 to update the ISO Topic and/or subtopic(s) with marked content of the website, an updated annotation, associated annotation, and other electronic information. For example, FIG. 9 illustrates a graphical user interface 900 with an updated outline 950 of the marked content of outline 850 of FIG. 8. For example, marked content for each mortgage rate of each listed website is updated. That is the marked content of the mortgage rate for www.myfavoritebank.com/rates shown as “5.45%” in FIG. 8 is updated in FIG. 9 to show the refreshed mortgage rate for www.myfavoritebank.com at “6.03%”. And, the marked content of the mortgage rate for www.usabank.com/rates shown as “5.90%” in FIG. 8 is updated in FIG. 9 to show the refreshed mortgage rate for www.usabank.com at “6.14%”. Further, other marked content (and/or an annotation, associated annotation, and other associated information) may be updated. For example, marked content of the phone number for Mr. John Smith shown as 703-123-4567 in FIG. 8 is updated to 571-123-4567 in FIG. 9. Similarly, the “refresh” button 860 may be used to update annotations, marked content, the address of a website, other associated files, and other associated electronic information. In addition, the graphical user interface 900 includes a “Saved Refreshed Topic” button 960 that may be activated by the user to archive the refreshed ISO profile (e.g., ISO Topic and/or subtopic) which may include additional edits inserted by the user (e.g., a comment making a comparison of the refreshed ISO profile with an earlier profile (e.g., “updated mortgage rates are higher”). Further, the graphical user interfaces 800 and 900 of FIGS. 8 and 9 include a “history” button 870. When the user activates the “history” button 870, another graphical user interface is presented that illustrates a history of the ISO Topic (and/or subtopic) such that an outline of the archived ISO Topic is presented and includes saved copies of the initial website (including initial marked content, other initial website information, and/or information associated with an electronic file) and the initial annotation (with links to other associated annotations, marked content, other topics/subtopics, and other associated electronic information) and further includes copies of each updated website and updated annotation with dates, times, name of user(s) associated with each archive, and/or other user specified rules. That is, for example, the history may include each page (of a website) that is annotated, that has marked content, and/or that has the website address saved and associates the search terms or keywords used to select the website (and/or marked content) including an original version and all subsequent versions with each version having a date, time, organization rules, and/or user specific information. In addition, FIG. 9 includes previously discussed toolbars 402 and 403 that enable a broad range of functionality for organizing, modifying, storing, linking, and/or otherwise managing annotations (and/or marked content) with a selected website, selected/marked content of a website, a selected electronic file, and/or a selected application.

According to an alternative exemplary embodiment, the ISO tool 110 may automatically update and/or otherwise modify the annotation, marked content, website address, and/or other associated electronic information. For example, the automatic update may operate according to one or more synchronization rules established by the user (or another user). Other exemplary methods for the automatic update may run according to one or more default synchronization rules, such as, for example, updating the annotation, the marked content, the website address, and other associated electronic information over a set time period (e.g., every 24 hours) or when an update to the annotation, the marked content, and/or other associated electronic information is detected (e.g., comparing a time and/or date stamp to see if the time and/or date stamp of the last saved information matches (or doesn't match) a time and/or date stamp of existing information (and if it doesn't match, then automatically updating the information). Those skilled in the art further understand that the program, processes, methods, and systems described in this patent are not limited to any particular rule for the automatic update.

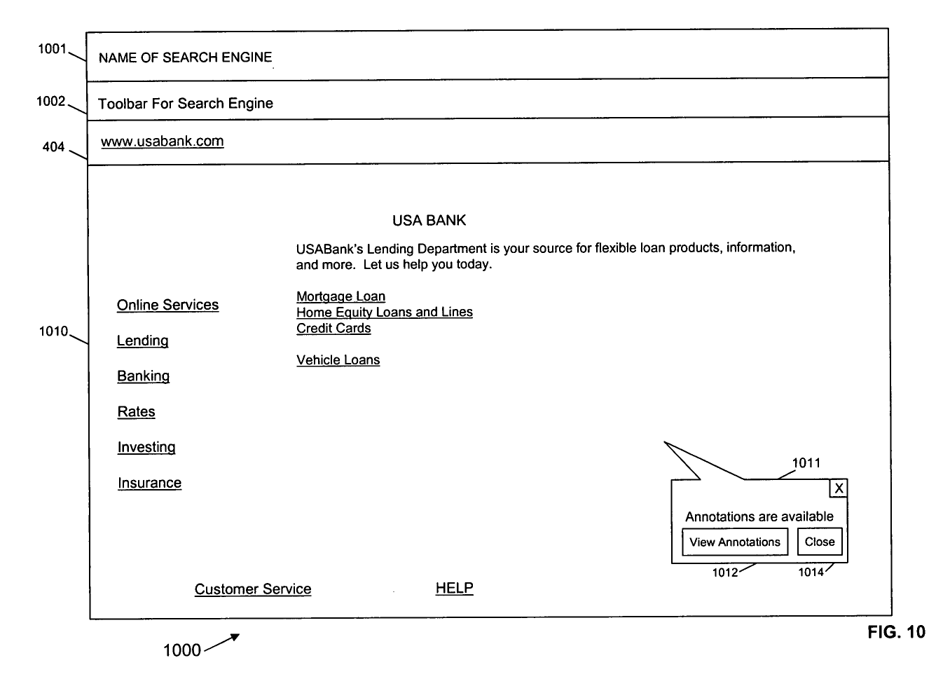

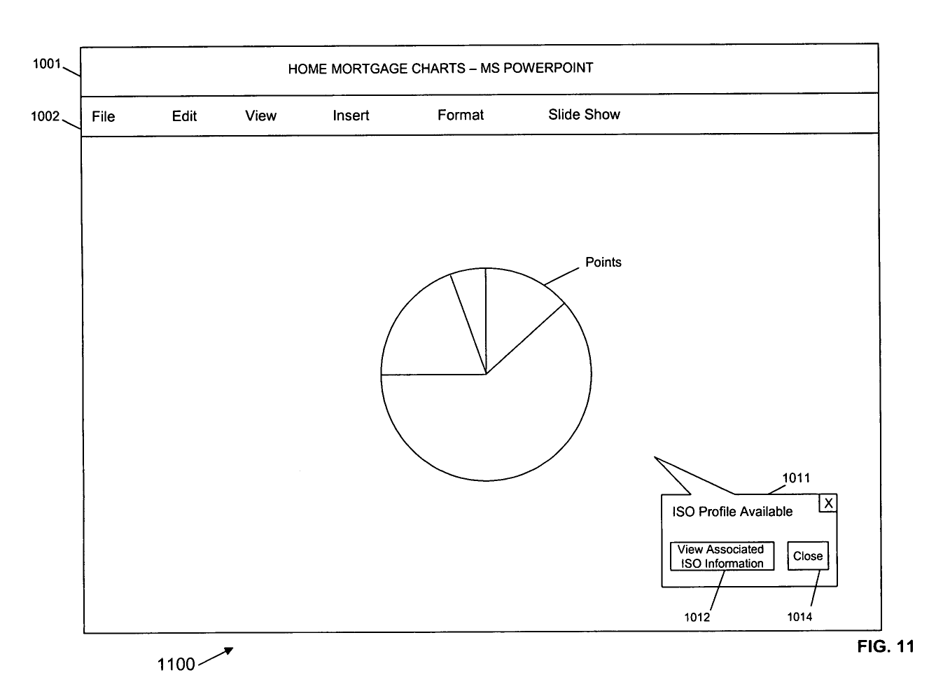

Further exemplary embodiments describe an alert, pop-up window, and/or an alternate audio and/or visual display 1011 as shown in graphical user interface 1000 and 1100 of respective FIGS. 10 and 11. The alert 1011 of FIG. 10 is generated when a website is viewed with the browser 120 of computer system 100 and indicates that the website is associated with an annotation, marked content, associated website, and/or other electronic information of an ISO Topic and/or subtopic. The alert 1011 of FIG. 11 is generated when an electronic file (shown as a Microsoft Power Point file) is opened and presented to a display device of computer system 100 and indicates that the electronic file is associated with an annotation, marked content, associated website, and/or other electronic information of an ISO Topic and/or subtopic. The user may activate a “View ISO information” button 1012 to view the associated annotation marked content, associated website, and/or other associated electronic information. Alternatively, the user may activate a “Close” button 1014 to close the alert. Still further, the alert may deactivate after a selected amount of time has elapsed, such as, for example, thirty (30) seconds.

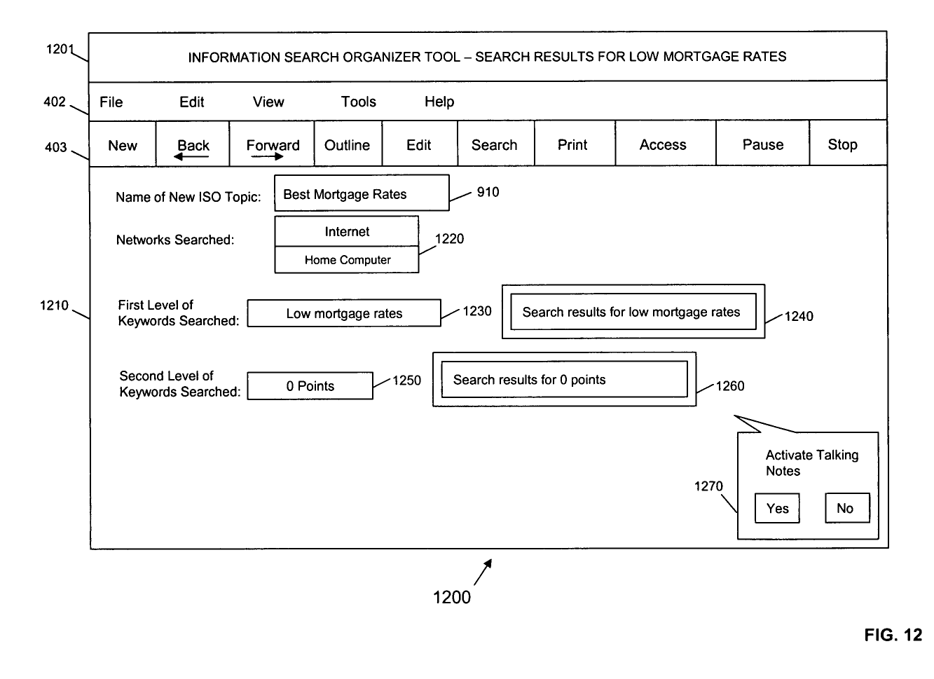

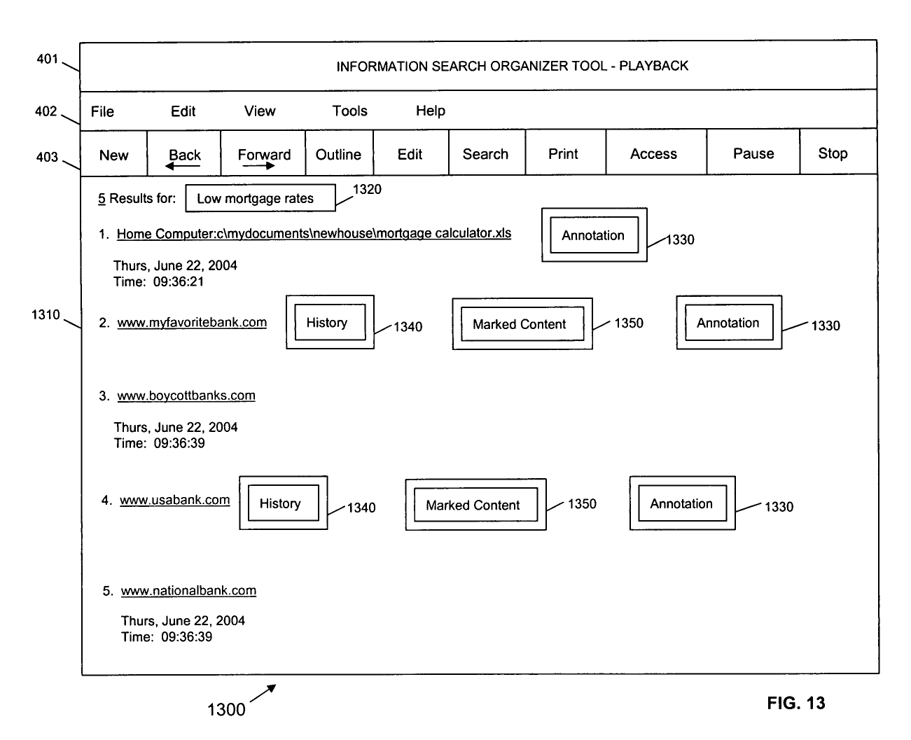

According to further exemplary embodiments, when the user activates the “View ISO information” button 1012, a graphical user interface 1200 of FIG. 12 is presented. The graphical user interface 1200 includes a display 1210 of the name of the ISO Topic 910 associated with the website or the electronic file, a listing of one or more networks searched 1220, a first level of one or more key words searched 1230, a button to activate to present one or more search results for the first level of key words 1240, a second level of one or more key words searched 1250, a button to activate to present one or more search results for the second level of key words 1260, and a pop-up window (or alternate audio and/or graphical presentation) for activating talking notes 1270 to present an one or more audio files corresponding to the ISO information. When the user activates the button 1240, a graphical user interface 1300 of FIG. 13 is presented with a display 1310 (and corresponding audio file(s) if the talking notes button 1270 is activated) of the search results for the first level of key words. For example, display 1310 indicates that 5 (five) results were found for the first level of keywords 1320 and includes a list 1350 of the results including the device, directory, subdirectory, and name of the electronic file and the website addresses. Further, each of the results includes a date and time stamp and may include one or more buttons that indicate if the electronic file or website is associated with an annotation 1330, history 1340 (indicating updated information associated with the result), and/or marked content 1350. If the electronic file or website is not associated with an annotation, history, and/or marked content, then no buttons are displayed with the result.

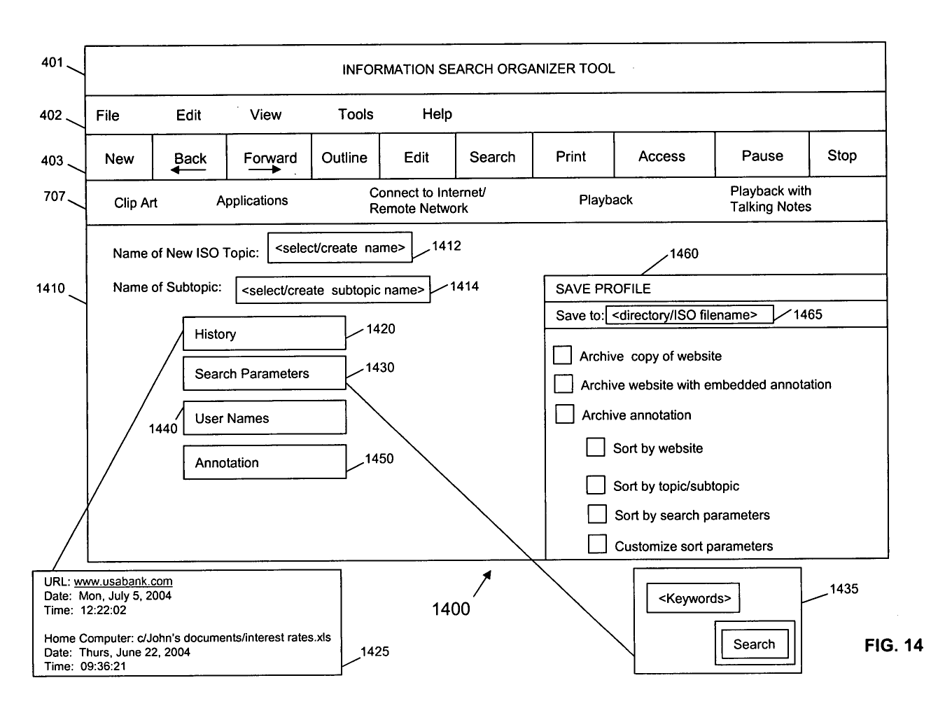

According to other exemplary embodiments, the user may either activate the “New” button of toolbar 403 (also shown in FIGS. 4-9 and 12-13), or alternatively, select an icon or menu selection for the ISO tool 110 on personal computer 100 to launch a new session to create a new ISO Topic and/or subtopic (or, alternatively, to select an existing ISO Topic and/or subtopic). FIG. 14 depicts an exemplary graphical user interface 1400 to create a new ISO Topic and/or subtopic (or alternatively, to select an existing ISO Topic and/or subtopic). The user may select the name of the ISO Topic using pull down menu 1412 to select a saved ISO Topic or to create a new ISO Topic. Similarly, the user may select the name of the subtopic using pull down menu 1414 to select an existing subtopic or create a new subtopic. A “History” button 1420 operates similarly to the “History” button of toolbar 403 and may provide historical information of an existing ISO Topic, such as, for example, the archive shown in reference numeral 1425. A “Search Parameters” button 1430 may provide search terms or key words of an existing ISO Topic, or, alternatively, the user may input keywords and subsequently initiate a search (using the “Search” button) to locate a website and/or an electronic data communications address having the keywords as shown in reference numeral 1435. An “Annotation” button 1450 may be activated to create an annotation or to select an existing annotation. A “Save Profile” 1460 as shown in the lower right hand corner of screen 1410 illustrates archiving features for the ISO tool 110. The user may input a directory and filename 1465 to save the ISO information for the ISO Topic (and/or subtopic). Further, the user may select one or more rules for saving the ISO information. For example, the user may select to archive a copy of the website (initial and subsequent, updated website data), archive the website with the embedded annotation (initial and subsequent, updated website and annotation data), and to archive the annotation. The annotation may further be sorted by website address (or alternate electronic data address of the file), sort by topic/subtopic, sort by search parameters such as keywords, and custom rules for sorting the annotations (e.g., sort by a value of associated marked text).

The Information Search Organizer tool (shown as reference numeral 110 in FIGS. 1-11) may be physically embodied on or in a computer-readable medium. This computer-readable medium may include CD-ROM, DVD, tape, cassette, floppy disk, memory card, and large-capacity disk (such as IOMEGA®, ZIP®, JAZZ®, and other large-capacity memory products (IOMEGA®, ZIP®, and JAZZ® are registered trademarks of Iomega Corporation, 1821 W. Iomega Way, Roy, Utah 84067, 801.332.1000, www.iomega.com). This computer-readable medium, or media, could be distributed to end-users, licensees, and assignees. These types of computer-readable media, and other types not mention here but considered within the scope of this invention, allow the Information Search Organizer tool to be easily disseminated.

Still in further exemplary embodiments, the Information Search Organizer tool may be physically embodied on or in any addressable (e.g., HTTP, I.E.E.E. 802.11, Wireless Application Protocol (WAP)) wireless device capable of presenting an IP address. Examples could include a computer, a wireless personal digital assistant (PDA), an Internet Protocol phone, a cellular phone, and any communications device having a digital signal processor.

While several exemplary implementations of embodiments of this invention are described herein, various modifications and alternate embodiments will occur to those of ordinary skill in the art. For example, other protocol requests for a website (or alternate electronic communications address), such as Hyper-Text Transfer Protocol (HTTP) and/or other protocols utilizing various formats, such as URL formats, Extensible Style Sheet (XSL) formats, Real Simple Syndication (RSS) that uses XML structures, and others may be similarly used to communicate orders from the private address of the multimedia device to a content source. Accordingly, this invention is intended to include those other variations, modifications, and alternate embodiments that adhere to the spirit and scope of this invention.

What we claim:

1. A method for providing a personal annotation, comprising:
accessing an electronic file associated with an electronic communications address, the electronic file comprising data of a website, data of a remotely stored electronic file, and a link to an electronic application;
selecting the electronic file for association with a personalized annotation; and
creating the personalized annotation, the personalized annotation comprising data describing the electronic file and a portion of the data of the electronic file.

2. The method of claim 1, further comprising:
storing the personalized annotation in a memory device of a computer system; and
classifying the personalized annotation using the electronic communications address and the annotation.

3. The method of claim 2, further comprising:
presenting an annotation profile of one or more classified, personalized annotations on a display device of the computer system.

4. The method of claim 3, further comprising:
communicating the annotation profile to a remote communications device; and
presenting the annotation profile to the remote communications device.

5. The method of claim 4, further comprising:
communicating a media control function to the multimedia content server via the communications network.

6. The method of claim 1, further comprising:
presenting an alert to the electronic communications address, the alert comprising a notification of the personalized annotation associated with the electronic communications address.

7. A personal annotation tool, comprising:
a communications interface for controlling access to and communications with a remote data source of an electronic file, the electronic file comprising data of a website, data of a remotely stored electronic file, and a communications link to an electronic application; and
a personal annotation module communicating with a communications module interface, the personal annotation module creating a personalized annotation associated with data of the electronic file, the personalized annotation comprising data describing the data of the electronic file and a portion of the data of the electronic file.

8. The personal annotation tool of claim 7, further comprising:
an application sharing interface controlling activation of an application to present one of the personalized annotation, the portion of the data of the electronic file, a data communications address of the electronic file, and an annotated file, the annotated file comprising the personalized annotation embedded within the data of the electronic file.

9. The personal annotation tool of claim 7, further comprising:
means for managing the personalized annotation with the electronic communications address.

10. The personal annotation tool of claim 7, further comprising:
means for managing the personalized annotation using data of the annotation, the data of the annotation comprising a topic, a subtopic, a keyword, and a priority indicator.

11. The personal annotation tool of claim 7, further comprising:
means for managing the portion of the data of the electronic file.

12. A storage medium on which is encoded instructions for performing the following:
accessing an electronic file of an electronic communications address, the electronic file comprising data of a website, data of a remotely stored electronic file, and a link to an electronic application;
selecting the electronic file to associate a personalized annotation; and
creating the personalized annotation, the personalized annotation comprising data to describe the electronic file and a portion of the data of the electronic file.

13. The storage medium of claim 12, further comprising instructions for performing the following:
storing the personalized annotation to a memory device of a computer system; and
managing the personalized annotation using the electronic communications address and the annotation.

14. The storage medium of claim 12, further comprising instructions for performing the following:
presenting an information search organizer topic on a display device of the computer system, the information search organization topic comprising the personalized annotation, the portion of the data of the electronic file, and the electronic communications address.

15. The storage medium of claim 14, further comprising instructions for performing the following:
communicating the information search organization topic to a remote communications device; and
presenting the information search organization topic to the remote communications device.

16. The storage medium of claim 12, further comprising instructions for performing the following:
storing the portion of the data of the electronic file to a memory device of a computer system; and
managing the personalized annotation using the portion of the data of the electronic file and the personalized annotation.

17. The storage medium of claim 12, further comprising instructions for performing the following:
storing the electronic communications address to a memory device of a computer system; and
managing the personalized annotation using the electronic communications address and the personalized annotation.

18. The storage medium of claim 12, further comprising instructions for performing the following:
presenting an alert to the electronic communications address, the alert comprising a notification of the personalized annotation associated with the electronic communications address.
